(19) United States
(12) Patent Application Publication
(10) Pub. No.: US 2002/0110214 A1
(43) Pub. Date: Aug. 15, 2002

(54) Circuit assembly for generating a phase-locked frequency-modulatable carrier frequency signal

(76) Inventor: Frank Vanselow, Freising (DE)

Correspondence Address: TEXAS INSTRUMENTS INCORPORATED, P O BOX 655474, M/S 3999, DALLAS, TX, 75265

(21) Appl. No.: 10/044,764

(22) Filed: Jan. 9, 2002

(30) Foreign Application Priority Data
Jan. 9, 2001 (DE) 101 00 555.5

(51) Int. Cl. H04L 7/00

(52) U.S. Cl. 375/376

(57) ABSTRACT

A circuit assembly (10) for generating a phase-locked frequency-modulatable carrier frequency signal contains a voltage-controlled oscillator (50) generating the carrier frequency signal as a function of a control signal. It furthermore contains a phase detector (44) which compares a reference frequency signal to a signal derived from the carrier frequency signal in phase therewith to thus produce the control signal so that the difference in phase between the signal derived from the carrier frequency signal and the reference frequency signal is zero. A reference frequency generator (36) is provided whose output signal is applied as the reference frequency signal directly to the phase detector (44). To generate the derived signal a mixer stage (30, 32, 38) is provided which mixes a signal output from a digital frequency generator (16) for modulating by digital signals in its frequency with a signal generated by frequency division from the carrier frequency signal output by the voltage-controlled oscillator (50) so that a signal materializes whose frequency equals the reference frequency.

The invention relates to a circuit assembly for generating a phase-locked frequency-modulatable carrier frequency signal including a voltage-controlled oscillator generating the carrier frequency signal as a function of a control signal, and a phase detector which compares a reference frequency signal to a signal derived from the carrier frequency signal in phase therewith to thus produce the control signal so that the difference in phase between the signal derived from the carrier frequency signal and the reference frequency signal is zero.

In wireless data communication in the ISM band (868 to 870 MHz) high demands as regards the permissible noise level need to be satisfied, noise suppression thus needing to be better than 64 dB. This results in a relatively high circuit complexity being needed to achieve circuits in which the signals are generated for transmission. In devices transmitting in the cited ISM band, for example, mobile radio telephones, the power is usually powered by batteries. It is for this reason that in achieving electronic circuits to be put to use for this purpose not only the requirements as cited above for a low noise level but also it needs to be assured that the circuits consume as little power as possible to make for a long battery life. In achieving such circuits integrated the surface area taken up by the individual circuit units on a semiconductor substrate is also a criterion which likewise must not be ignored.

Known already is a circuit assembly of the aforementioned kind in which for generating a phase-locked carrier signal, a conventional phase-locked loop is put to use. The reference frequency generator employed in this conventional phase-locked loop is a digital frequency generator whose output frequency can be modulated with the data to be transmitted. The phase-locked loop contains as usual a voltage-controlled oscillator which provides the carrier frequency signal at its output. This oscillator is controlled by the output signal of a phase detector which compares the phase of the signal generated by the frequency generator to the phase of a signal obtained by frequency division of the output signal of the voltage-controlled oscillator. In this known circuit assembly the digital frequency generator generates a frequency which is low in comparison to the output signal of the voltage-controlled oscillator, resulting in the factor of the circuit dividing this frequency of the signal output by the voltage-controlled oscillator needing to be very high so that two signals are applied to the input of the phase detector whose frequency is the same. This high dividing factor turns out to be a nuisance, however, since the noise frequency level is proportional to the dividing factor. Although using a digital frequency generator having a substantially higher reference frequency would make it possible to achieve a lower dividing factor, such a digital frequency generator takes up a great deal of space on the semiconductor substrate in an integrated circuit which in turn would make for a high power consumption.

The invention is based on the object of providing a circuit assembly of the aforementioned kind which satisfies the requirement for a low noise level in the ISM band and can be fabricated with a low surface area requirement and power consumption as an integrated circuit.

In accordance with the invention this object is achieved in that a reference frequency generator is provided whose output signal is applied as the reference frequency signal directly to the phase detector, that for generating the derived signal a mixer stage is provided which mixes a signal output from a digital frequency generator for modulating by digital signals in its frequency with a signal generated by frequency division from the carrier frequency signal output by the voltage-controlled oscillator so that a signal materializes whose frequency equals the reference frequency.

In the circuit assembly in accordance with the invention the digital frequency generator is configurable so that it generates a frequency which is very low as compared to the carrier frequency to be transmitted. To avoid a high factor by which the carrier frequency signal is to be divided before being applied to the phase detector, the signal generated by the digital frequency generator is not directly applied to the phase detector for comparison with the reference frequency signal, it instead being converted by it being mixed in the range of the frequency of the reference frequency signal. The phase detector is then able to implement the phase comparison between the reference frequency signal directly received by the reference frequency generator and the signal generated by mixing the output signal of the voltage-controlled oscillator divided in its frequency and the output signal of the digital frequency generator. The circuit assembly in accordance with the invention thus enables the digital frequency generator to be configured with a low surface area requirement and power consumption since it needs to generate only a signal of low frequency and in the feedback branch of the phase-locked loop a low frequency division factor can be put to use which greatly contributes towards maintaining the required low noise level.

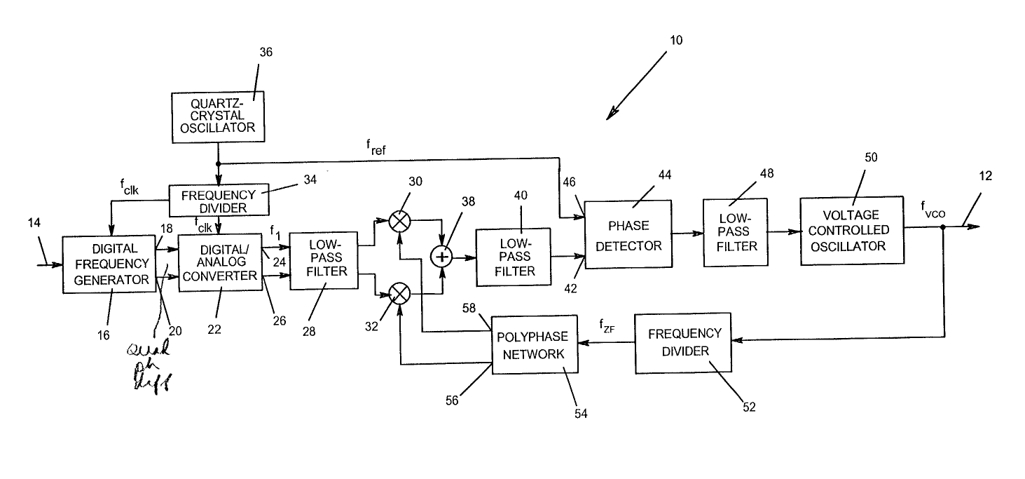

An example embodiment of the invention will now be detailed with reference to the drawing, the sole FIG. 5 of which is a block diagram of the circuit assembly in accordance with the invention.

The circuit assembly 10 as shown serves to generate at an output 12 a phase-locked carrier frequency signal which can be modulated in its frequency with the aid of a data signal applied to a data input 14. The data signal in this case is a digital signal consisting of a string of binary signals having the value 0 or 1. Depending on which binary value is applied to the data input 14 at the time, the signal output at the output 12 has one of two possible frequency values. The modulation involved is thus frequency shift keying, generally termed also as FSK modulation.

For the purpose of the following description it is assumed that a signal having a specific binary value is applied to the data input 14. This signal prompts a digital frequency generator 16 to generate at its outputs 18 and 20 digital signals having a specific frequency. In this arrangement the digital frequency generator 16 is configured so that it generates complex output signals, meaning that the signals generated by the two outputs 18 and 20 are 90° out of phase. In a digital/analog converter 22 these signals are converted into analog signals at the outputs 24 and 26 and after passing through a low-pass filter 28 are applied to the two mixer units 30 and 32 respectively.

As evident, the digital frequency generator 16 and the digital/analog converter 22 are controlled by clock signals output by a frequency divider 34. This frequency divider 34 divides the frequency of an oscillating signal generated by a quartz-crystal oscillator 36 by a specific factor so that the desired clock signal for controlling the digital frequency generator 16 and the digital/analog converter 22 is generated therefrom.

The output signals of the mixer units 30, 32 are summed in an adder 38 and applied via a low-pass filter 40 to an input 42 of a phase detector 44. This phase detector 44 receives at a second input 46 the oscillator signal from the quartz-crystal oscillator 36 as the reference frequency signal. The phase detector 44 generates as a function of the phase difference between the signals applied to its inputs 42 and 46 an output signal which is applied via a low-pass filter 48 to a voltage-controlled oscillator 50 which outputs the desired carrier frequency signal as controlled by this output signal.

To achieve the phase comparison the carrier frequency signal generated by the voltage-controlled oscillator 50 is first divided in its frequency in a frequency divider 52 by a specific factor, the output signal having the corresponding lower frequency then being applied to a polyphase network 54 which generates from the signal applied thereto two corresponding complex signals at the outputs 56 and 58 which are 90° out of phase relative to each other. With these two signals the complex signals applied to the mixer units 30, 32 from the low-pass filter 28 are then mixed. The signal applied to the input 42 of the phase detector 44 is thus specifically phase-related—via the feedback loop comprising the frequency divider 52, polyphase network 54, mixer units 30, 32, adder 38 and low-pass filter 40—to the phase condition of the signal generated by the voltage-controlled oscillator 50 so that the desired phase control can be implemented. In this arrangement the phase detector 44 ensures by known ways and means, the same as in a conventional phase-locked loop, that one such output signal is generated so that by controlling the voltage-controlled oscillator 50 the phase difference of the signals at its inputs 42 and 46 disappears. The carrier frequency signal at the output 12 is thus locked in phase to the phase of the reference frequency signal generated by the quartz-crystal oscillator 36.

The special advantages of the circuit assembly 10 as described hitherto as regards its configuration become evident when concrete frequency values and dividing ratios are considered as put to use in the circuit assembly 10.

As mentioned at the outset, the output signal of the circuit assembly is required to be in the ISM band in the frequency range 868 to 870 MHz. It is assumed in the following, for example, that the output signal of the voltage-controlled oscillator 50 is required to have the frequency f_{VCO}=869 MHz by it being mixed, it also being assumed that the data signal at the data input 14 has a constant value so that the output frequency of the voltage-controlled oscillator 50 does not change.

The quartz-crystal oscillator 36 generates a reference frequency f_{ref} of 27 MHz. The frequency divider 34 has the dividing factor 12 so that the clock frequency f_{clk} output by it has the value 2.25 Mhz. The digital frequency generator 16 is configured so that is generates an output frequency of 156 kHz as controlled by this clock signal. This frequency is also output by the digital/analog converter 22 at the outputs 24 and 26 and applied via the low-pass filter 28 tothe mixer units 30 and 32.

The reference frequency f_{ref} generated by the quartz-crystal oscillator 36 is also applied to the input 46 of the phase detector 44 as the reference frequency.

The frequency f_{VCO} of the signal output by the voltage-controlled oscillator 50 is divided in the frequency divider 52 by the factor 32 so that the frequency f_{ZF}=27.156 MHz is available at its output. As already mentioned it is from the signal having this frequency that in the polyphase network 54 a complex signal is generated at the outputs 58 and 56 which has likewise the frequency f_{ZF}. By mixing these signals with the output signals of the lowpass filter 28 signals are generated by the mixer units 30 and 32 whose frequency spectrum in each case has a 27 MHz component and a 27.314 MHz component in each case. By summing these complex mix signals in the adder 38 the 27.314 MHz components are eliminated so that via the low-pass filter 40 a signal is applied to the phase detector 44 which has the frequency 27 MHz. Due to the phase control effect the phase detector 44 always ensures that the difference in phase in the signals applied to its input 42, 46 is zero. This is achieved by it generating such an output signal for controlling the voltage-controlled oscillator 50 that the phase of the frequency f_{VCO} is adjusted so that the desired phase condition materializes at the input of the phase detector.

The example as described shows that the digital frequency generator 16 needs to generate only a very low frequency, resulting in it being achievable in an integrated circuit with a low space and power requirement. So that the phase comparison does not need to be implemented in the phase detector 44 with signals likewise having this low output frequency of the digital frequency generator 16, these output signals are converted by mixing to a substantially higher frequency, namely the reference frequency f_{ref} generated by the quartz-crystal oscillator 36. It is due to this conversion to a higher comparison frequency that the factor of the frequency divider 52 can be maintained at a substantially lower value than would be the case when the phase comparison is implemented at the low output frequency of the digital frequency generator 16. In the example as described a dividing factor of 32 is sufficient. Using this low dividing factor avoids the noise level being excessively elevated in the output signal of the voltage-controlled oscillator 50 by the effect of the frequency divider 52.

Thus, making use of the circuit assembly as described simultaneously achieves a simple assembly in the form of an integrated circuit whilst assuring a low noise level to thus permit satisfying the strict requirements as applicable for operation in the ISM band.

What is claimed is:

1. A circuit assembly for generating a phase-locked frequency-modulatable carrier frequency signal including a voltage-controlled oscillator generating the carrier frequency signal as a function of a control signal, and a phase detector which compares a reference frequency signal to a signal derived from the carrier frequency signal in phase therewith to thus produce the control signal so that the difference in phase between the signal derived from the carrier frequency signal and the reference frequency signal is zero, characterized in that a reference frequency generator (36) is provided whose output signal is applied as the reference frequency signal directly to said phase detector (44), that for generating the derived signal a mixer stage (30, 32, 38) is provided which mixes a signal output from a digital frequency generator (16) for modulating by digital signals in its frequency with a signal generated by frequency division from the carrier frequency signal output by said voltage-controlled oscillator (50) so that a signal materializes whose frequency equals the reference frequency.

2. The circuit assembly as set forth in claim 1, characterized in that said digital frequency generator (16) generates the signal modulatable in its frequency as a complex signal having two components 90° out of phase relative to each other, that these two components after being converted into analog signals are applied to said mixer stage (30, 32, 38) in which a mixer unit (30, 32) is provided for each component, that one component each of a complex signal generated by a polyphase network (54) from the signal obtained from the carrier frequency signal by frequency division is applied to said mixer units, and that the output signals of said mixer units (30, 32) are combined for sideband suppression and the combined signal applied to said phase detector (44).
